(19) United States
(12) Patent Application Publication
(10) Pub. No.: US 2019/0135245 A1
(43) Pub. Date: May 9, 2019

(54) METHOD OF OPERATING THE POWER TRAIN OF A VEHICLE

(71) Applicant: ZF Friedrichshafen AG, Friedrichshafen (DE)

(72) Inventors: Hans PILZWEGER, Neuhaus am Inn (DE); Alexander STÖBICH, Wegscheid (DE)

(21) Appl. No.: 16/183,796

(22) Filed: Nov. 8, 2018

(30) Foreign Application Priority Data
Nov. 9, 2017 (DE) 10 2017 219 969.5

(51) Int. Cl. B60T 7/12; B60T 8/34; B60T 8/58

(52) U.S. Cl. CPC B60T 7/12; B60T 8/34; B60T 2260/04; B60T 2201/06; B60T 8/58

(57) ABSTRACT

A method of operating a drive-train of a vehicle having a drive engine, a motor vehicle transmission, at least one drive axle and a further axle that can be engaged to drive. In context of a function, a connection between the drive engine and the at least one drive axle of the vehicle is automatically interrupted, and the function is automatically activated when certain conditions exist. For the activation of the function, a service brake of the vehicle must be actuated and, as a condition, the vehicle must be stopped. To check whether operation of the vehicle in the all-wheel mode is necessary, when the function is carried out, a brake pressure is determined and, if the brake pressure exceeds a brake pressure limit value, the driving engagement of the further axle is carried out automatically as the function is deactivated for re-starting the vehicle.

This application claims priority from German patent application serial no. 10 2017 219 969.5 filed Nov. 9, 2017.

### FIELD OF THE INVENTION

The invention relates to a method for operating a drive-train of a motor vehicle, in particular an agricultural or municipal utility vehicle, with a drive engine, a motor vehicle transmission and at least one drive axle and a further axle that can be drivingly engaged, wherein a connection between the drive engine and the at least one drive axle of the motor vehicle is automatically separated in the context of a function which is automatically activated when certain conditions exist and wherein, for the activation of the function, a service brake of the motor vehicle has to be actuated and, as a condition, the vehicle must have been braked to rest. In addition the invention relates to a control unit for a drive-train of a motor vehicle, a computer program product and a data carrier with the computer program product.

### BACKGROUND OF THE INVENTION

In motor vehicles having automated manual transmissions or automatic transmissions, even if the driver of the vehicle does not actuate the accelerator pedal, drive movement from a drive engine of the motor vehicle is usually transmitted to the drive axle or axles of the motor vehicle, which then results in a forward movement despite the fact that the accelerator pedal has not been actuated. To bring the motor vehicle to a stop the driver of the vehicle has to actively actuate the service brake concerned, which causes the drive engine to work in opposition to the service brake and thereby also increases the consumption of fuel.

To avoid this higher fuel consumption, in motor vehicles it is known, in the context of a related function, to separate a connection between the drive engine and the drive axle or axles of the motor vehicle and thereby to prevent the forward movement of the motor vehicle in a controlled manner. The activation and deactivation of the function take place as a function of the actuation of the service brake.

Thus, WO 2006/102977 A1 discloses a method in which a connection between a drive engine of a motor vehicle and a drive axle and a drivingly engaged additional axle of the motor vehicle is separated in the context of a function. By means of the method described in WO 2006/102977 A1 rolling away of a motor vehicle that is standing on an incline should be prevented. For this, when the motor vehicle is stopped by actuating a service brake, i.e. when it is decelerated down to a rest, a specified brake pressure is built up and maintained. During a holding phase of limited time, for the purpose of recognizing slippage a wheel is decoupled from the drive input by actuating a coupling unit and the brake pressure existing at that wheel is reduced whereas the other wheels remain acted upon by the specified brake pressure. To recognize slippage, a rotational speed sensor is used to monitor whether during this holding phase any rolling of the one wheel concerned takes place. If that wheel rolls, it is recognized that the motor vehicle is slipping despite its braked wheels since the holding power of the remaining wheels is not sufficient. To ensure the greatest possible traction when later re-starting the vehicle, before the lapse of the holding phase the coupling unit is controlled in such manner that the drive axle and the axle that can be engaged are re-connected to the drive engine.

### SUMMARY OF THE INVENTION

Starting from the prior art described above, the purpose of the present invention is now to provide a method of operating a drive-train of a motor vehicle which enables more efficient control of the drive-train.

From the process-technological standpoint this objective is achieved with the characterizing features of the independent claims. From the standpoint of equipment technology, the objective is achieved by the technical characteristics of the independent claims. The dependent claims that follow in each case each describe advantageous further developments of the invention. In addition, a computer program product and a data carrier on which it is stored are also the objects of the independent claims.

According to the invention, in a method of operating a drive-train of a motor vehicle, in particular an agricultural or municipal utility vehicle, with a drive engine, a motor vehicle transmission and at least one drive axle and a further axle that can be drivingly engaged, a connection between the drive engine and the at least one drive axle of the motor vehicle is automatically separated in the context of a function which is automatically activated when certain conditions exist. In this case, to activate the function, a service brake of the motor vehicle has to be actuated and, as a condition, the vehicle must have been braked to rest.

Thus, by virtue of the function, the transmission of drive movement from the drive engine to the at least one drive axle of the motor vehicle is automatically prevented and during this the connection to a further axle that can be drivingly engaged, or even a plurality of drive axles of the motor vehicle, is interrupted depending on how many drive axles the motor vehicle has. Accordingly the function serves to prevent the motor vehicle from crawling forward. A necessary condition for the automatic triggering of the function is that the service brake has been actuated by a driver of the vehicle.

In the context of the invention, the drive engine is, in particular, an internal combustion engine which, within the drive-train, can be connected to the drive axles concerned by way of an intermediate starting element, a motor vehicle transmission and a respective axle transmission. The motor vehicle is preferably a municipal or agricultural utility vehicle, in particular an agricultural tractor.

The invention is now based on the technical principle that when the function is activated, a brake pressure is determined and if the brake pressure exceeds a brake pressure limit value, the driving engagement of the further axle when the function is deactivated is carried out automatically for re-starting the motor vehicle. In other words, the further axle is drivingly engaged only when operating conditions for it exist, which also require this in order to increase the traction when re-starting the motor vehicle. For this, the existence of corresponding operating conditions is concluded with reference to the brake pressure determined. The brake pressure concerned can be the pressure applied in order to decelerate the vehicle down to rest, or a brake pressure required in order to hold the vehicle still on an incline. If the brake pressure determined exceeds the brake pressure limit value, an operating condition is deemed to exist in which an elevated traction during the re-starting of the motor vehicle is required, so that the further axle is automatically engaged before the function has been deactivated. For example this can be the case when the vehicle is standing on an incline. A further operating situation which demands a higher traction for starting arises if a trailer, especially a fully loaded one, or some other attachment is coupled to the motor vehicle. By engaging the further axle, the motor vehicle can be operated as an all-wheel-drive motor vehicle, whereby the slipping of wheels of the motor vehicle while starting is prevented. Other influences on the operating situation can include the condition of the ground over which the vehicle is driving, and the weather conditions at the time. These influences will also vary the brake pressure that needs to be applied in order to brake the vehicle until it is at rest. The operating-situation-dependent engagement of the further axle so that the motor vehicle can be operated as an all-wheel vehicle increases comfort before the starting process, since during the time following the starting process, thanks to the engagement of the further axle, no instability in the movement of the vehicle is caused by engaging the further axle that could be perceived as jerkiness. Furthermore, this improves the consumption efficiency of the motor vehicle.

In contrast, in the method according to WO 2006/102977 A1, all-wheel driving after the activation of the function is temporarily interrupted in order to recognize slipping, and then is automatically re-engaged independently of the operating situation at the time.

In accordance with an embodiment, if a speed limit is exceeded after re-starting, the driving connection of the further axle is automatically interrupted. This has the advantage that sustained stress in the drive-train can be avoided, which reduces wear. In addition the automatic discontinuation of all-wheel drive has a positive effect on fuel consumption.

In a possible embodiment of the invention, the brake pressure limit value is parameterized based on the mode of operation of the motor vehicle. A mode of operation is understood to mean the operation of the motor vehicle, in particular one designed as an agricultural utility vehicle with at least a trailer and/or another attachment coupled to it. The resulting increase of the total weight of the combination consisting of the motor vehicle and at least one trailer demands that particularly for starting on an incline, the traction should be increased.

In a further development of the invention, the mode of operation can be determined by the recognition of attachments that can be fitted onto equipment connected to the motor vehicle, which increase the total weight of the motor vehicle. For example, the attachment could be a trailer such as a transport or load-carrying wagon or attachment. In particular, the effect on the starting behavior of attaching working equipment at the rear, especially on an incline, is that if the further axle is not drivingly engaged, the drive wheels on the drive axle will slip.

For this purpose, the working equipment can be connected by a bus system to the motor vehicle control-technology. Thanks to the bus system information about the working equipment connected to the motor vehicle can be communicated, which information can be used to determine an operating-mode-specific brake pressure limit value. Particularly with an agricultural utility vehicle the communication can take place, for example, by way of the so-termed ISO bus system.

In a further development of the invention, it is provided that the brake pressure in at least one brake circuit of the service brake is detected. In that way agricultural utility vehicles can have two separate brake circuits which apply brake pressures of different values in order to reduce a turning radius of the utility vehicle. For example, it can be appropriate to determine the brake pressure of both brake circuits in order to be able to distinguish between a braking process intended to bring the utility vehicle to a rest and a braking process carried out in order to reduce the turning radius. This avoids inadvertent activation of the function.

In a further development of the invention, the separation and re-establishment of the connection between the drive engine and the at least one drive axle of the motor vehicle is effected by a starting element arranged between the drive engine of the motor vehicle and the motor vehicle transmission. Also preferably, the starting element is a separator clutch by means of which the mechanical connection between the drive engine and the motor vehicle transmission is interrupted when the clutch is in the open condition. In this context the separator clutch can be a dry-running or a wet-running friction clutch. Alternatively, however, it is also conceivable to separate the connection between the drive engine and the drive axle at some other point in the drive-train, for example by selective actuation of the shifting device of the transmission from an engaged gear to a neutral position.

Moreover, the further axle is drivingly engaged by controlling a clutch unit in order to enable the all-wheel drive mode of the motor vehicle. The clutch unit can be in the form of an electronically controlled frictional disk clutch. By controlling the clutch unit before starting off, the useful life of the clutch unit is extended since the engagement takes place in an almost load-free condition.

Within a motor vehicle drive-train, the method according to the invention is preferably regulated by means of a control unit, this being in particular the control unit of a starting element arranged in the drive-train. In this case, the control unit comprises a device for regulating a function that separates a connection formed between a drive engine and at least one drive axle of the motor vehicle by means of the starting element, such that the device is designed for the automatic control of a clutch unit for the driving connection of a further axle to the drive engine of the motor vehicle drive-train. The device for the automatic control of the clutch unit can also be in the form of a separate device of the control unit. The function activated by the device in the drive-train separates a connection between the drive engine and the at least one drive axle of the motor vehicle by means of the starting element. In this context, for activating the function, a service brake of the motor vehicle must have been actuated and, as a condition, the motor vehicle must have been braked to a stop. During this, when the function is carried out a brake pressure applied can be determined, which pressure has to be exceeded for an automatic engagement of the further axle. To obtain the operating condition of the service brake and to determined the brake pressure applied and compare it against the brake pressure limit value, the control unit is in particular connected into a data bus system of the motor vehicle and in that way communicates with other control devices. A plurality of brake pressure limit values can be stored in the control unit, which are used for the comparison with the brake pressure determined as a function of the operating mode of the motor vehicle. The brake pressure limit values can be varied in order to adapt them to different operating modes and/or operating situations.

The system according to the invention can also be incorporated as a computer program product which, when run on a processor of a control unit, instructs the processor by software means to carry out the associated process steps in accordance with the object of the invention. In this connection the object of the invention also includes a computer-readable medium in which a computer program product as described above is recoverably stored.

The invention is not limited to the combination of characteristics indicated in the independent claims or the claims that depend on them. There are in addition possibilities for combining individual features with one another, provided that they emerge from the claims, the description of preferred embodiments of the invention given below, or directly from the figures. References in the claims to the figures by the use of indexes are not intended to restrict the protective scope of the claims.

### BRIEF DESCRIPTION OF THE DRAWINGS

An advantageous embodiment of the invention, which is explained below, is illustrated in the figures, which show:

FIG. 1: A schematic representation of a drive-train of a motor vehicle;

FIG. 2: A flow chart of a method for operating the drive-train of FIG. 1, corresponding to a preferred embodiment of the invention.

### DETAILED DESCRIPTION OF THE PREFERRED EMBODIMENTS

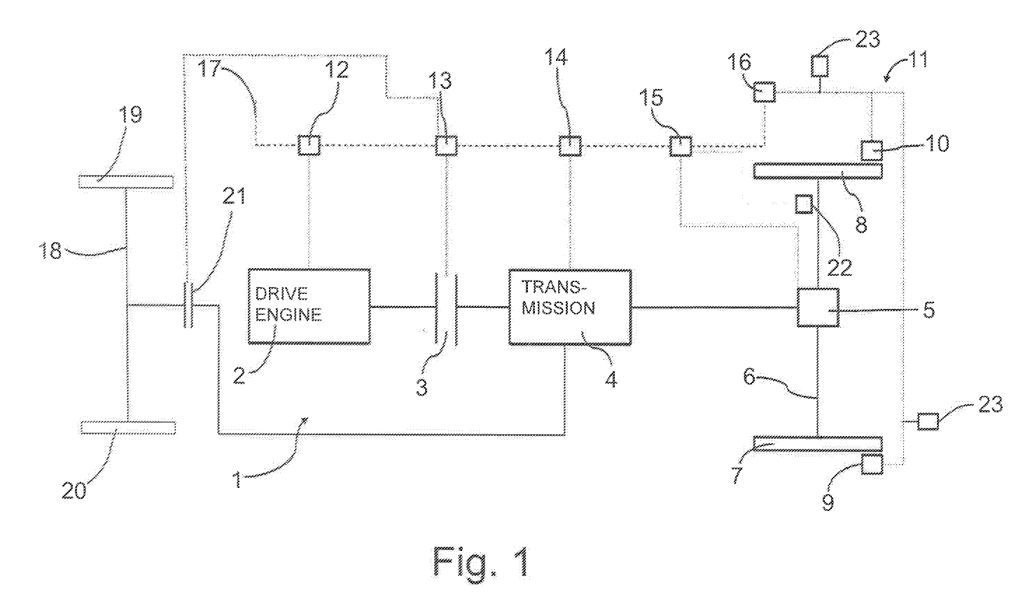

FIG. 1 shows a schematic representation of a drive-train 1 of a motor vehicle, which is preferably an agricultural or municipal utility vehicle and more preferably still an agricultural tractor. The drive-train 1 comprises a drive engine 2 in the form of an internal combustion engine which, on a drive output side, can be connected by way of an intermediate starting element 3 to a downstream motor vehicle transmission 4. While the starting element 3 is preferably a dry-running or wet-running friction clutch, the motor vehicle transmission 4 is in particular a manual transmission.

As can also be seen from FIG. 1, on its drive output side the motor vehicle transmission 4 is connected to an axle transmission 5 of a drive axle 6 so that by way of the axle transmission 5 drive movement of the drive engine 2, geared by the motor vehicle transmission 4, is distributed to two drive wheels 7 and 8 of the drive axle 6. Associated with each of the drive wheels 7 and 8 is a respective wheel brake 9 or 10 of a service brake system 11 of the motor vehicle, which when actuated, brakes the drive wheel 7 or 8 concerned. In this case the drive wheels 7 and 8 can be braked independently of one another so as to increase the maneuverability of the motor vehicle.

In addition an axle 18 that can be drivingly engaged is provided, which has wheels 19, 20. In this drive-train 1, the axle 18 can be connected by a controllable clutch unit 21 in such manner that both the drive wheels 7, 8 of the drive axle 6 and the wheels 19, 20 of the further axle 18 are driven. The clutch unit 21 can be in the form of an electronically controlled frictional disk clutch.

The drive engine 2, the starting element 3 and the clutch unit 21, the motor vehicle transmission 4, the axle transmission 5 and also the service brake system 11 are in each case associated with respective control units 12 or 13 or 14 or 15 or 16, which are connected with further control units—not shown in greater detail here—by a data bus system 17 of the motor vehicle and which communicate with one another. In this case the control unit 12 regulates the drive engine 2, while by means of the control unit 13 an automated opening and closing of the starting element 3 and, independently of the control of the starting element 3, opening and closing of the clutch unit 21 can be regulated. Besides this automated operation of the starting element 3, however, the starting element 3 can also be optionally opened and closed in accordance with the wishes of the driver of the vehicle, for which purpose the control unit 13 is connected to a clutch pedal—not shown further here. The clutch unit 21 can also be controlled manually in accordance with a driver's wish, in order when necessary to enable all-wheel operation of the motor vehicle.

The control unit 14 is associated with the motor vehicle transmission 4 and can regulate it in the manner of an automated change-speed transmission, such that in this case too it is possible to carry out shifting operations in a manual mode in accordance with the driver's wishes. Finally, the control unit 15 is associated with the axle transmission 5 and with a rotational speed sensor 22, and the control unit 16 is associated with the service brake system 11. The control unit 16 receives from at least one pressure sensor 23 signals for evaluation, which signals indicate the brake pressure p_{Brems} applied.

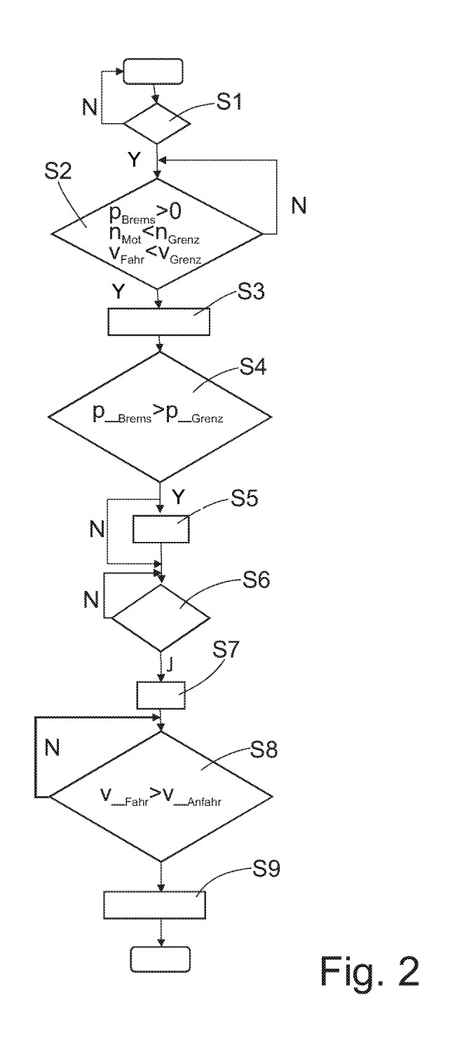

In the context of a function, the control unit 13 can bring about the automated opening and closing of the starting element 3, in order to obtain a start-stop function of the motor vehicle by separating the connection between the drive engine 2 and the motor vehicle transmission 4. For this, the existence of at least one condition is checked, which condition is a prerequisite for the automatic opening of the starting element 3. This condition is the actuation of the service brake 11, which among other things can be detected by monitoring the brake pressure p_{Brems}. Furthermore the control unit 13 can control the clutch unit 21 as a function of the brake pressure p_{Brems} which, respectively, would be or is applied for braking the motor vehicle to a stop or for holding the motor vehicle. Depending on the brake pressure p_{Brems} detected at the time, the operating situation of the motor vehicle is concluded in order to control the clutch unit 21 appropriately for the operating situation concerned, i.e. to decide whether to drivingly engage the axle 18 for re-starting. In this way it is possible to avoid an operating situation in which, when the motor vehicle is re-started, slipping of the drive wheels 7, 8 takes place since the traction is too low because the axle 18 has not been engaged. For this, the control unit 13 regulates the starting element 3 and the clutch unit 21 in accordance with the method represented in FIG. 2:

At the beginning of the process, in a step S1 it is questioned whether the function for the automated opening and closing of the starting element 3 is activated. If not, the process returns to the beginning and no further action is taken.

On the other hand if the result in step S1 is positive, the process advances to a step S2. In step S2 the existence of at least one condition is checked, which is a prerequisite for the automatic opening of the starting element 3. This includes the actuation of the service brake 11, which among other things can be detected by monitoring the brake pressure p_{Brems}. The actuation or release of the service brake 11 results in an actuation of brake light switches associated with a brake pedal mechanism. The actuation conditions of the two wheel brakes 9 and 10 can be checked with reference to the actuation conditions of the respective brake light switches and taken into account as a further condition which is a prerequisite for the triggering of the function for opening the starting element 3. In addition, in step S2 it is questioned whether a rotational speed n_{Mot} of the drive engine is lower than a rotational speed limit value n_{Mot}. Another condition in step S2 is whether a vehicle speed v_{Fahr} is lower than a limit value v_{Grenz}, which initiates the determination of the brake pressure p_{Brems} applied by the service brake 11. If all the conditions specified in step S2 are fulfilled, the process progresses to a step S3, whereas otherwise the process reverts to before step S2.

In step S3 the starting element 3 is automatically opened and thereby the connection between the drive engine 2 and the motor vehicle transmission 4 is separated. In addition, in step S3 the brake pressure p_{Brems}, or its variation is evaluated by the control unit 16, which pressure has been applied to brake the motor vehicle to rest or is being applied to hold the motor vehicle. From this it can be concluded whether for example the motor vehicle is on an incline and/or whether it is towing a trailer, particularly a fully loaded one.

Thereafter, in a step S4 it is checked whether the brake pressure p_{Brems} evaluated by the control unit 16 exceeds a specifiable brake pressure limit value p_{Grenz}. With reference to the comparison of the brake pressure p_{Brems} with the specifiable brake pressure limit value p_{Grenz}, it is concluded whether the vehicle is on an incline and/or whether the vehicle or a trailer it is towing are fully loaded. If the brake pressure limit value p_{Grenz} has been exceeded, then in the next step S5 the clutch unit 21 is automatically controlled in order to connect the axle 18 drivingly into the drive-train 1 so that the wheels 18, 19 are also driven. The process then advances to a step S6, whereas in the opposite case the process jumps directly from step S4 to step S6.

In step S6 it is checked whether the driver of the vehicle has indicated a wish to close the starting element 3 by the automatic deactivation of the function or by virtue of a manual control action, in order to be able to start the motor vehicle. If the result in step S6 is positive, then in a step S7 the starting element 3 is closed so that the drive engine 2 and the motor vehicle transmission 4 are connected to one another.

During the starting process the actual driving speed v_{Fahr} is monitored and sent to the control unit 13 by way of the bus system 17. In step S8 the driving speed v_{Fahr} is compared with a limit value v_{Anfahr} of the vehicle speed, which is generally different from the limit value v_{Grenz}. The specifiable or variable limit value v_{Anfahr} is for example stored in the control unit 12 or 14. If the limit value vᵣ, is exceeded by the actual driving speed v_{Fahr}, then in step S9 the clutch unit 21 is controlled by the control unit 13 in such manner that the driving connection to the axle 18 is automatically interrupted and the all-wheel drive is therefore automatically discontinued. In the opposite case the process reverts to before step S8 and the engagement remains in place. After the step S9, the function then ends.

By virtue of the design according to the invention, of a method for operating a drive-train of a motor vehicle, in the context of an automatic function the traction during a starting process can be increased by the automatic engagement of the further axle of the motor vehicle in order to avoid slipping of the drive wheels, in that by checking the brake pressure it can be concluded whether the motor vehicle is on an incline and/or whether the motor vehicle or a trailer are fully loaded.

### INDEXES

1 Drive-train
2 Drive engine
3 Starting element
4 Motor vehicle transmission
5 Axle transmission
6 Drive axle
7 Drive wheel
8 Drive wheel
9 Wheel brake
10 Wheel brake
11 Service brake
12 Control unit
13 Control unit
14 Control unit
15 Control unit
16 Control unit
17 Data bus system
18 Axle
19 Wheel
20 Wheel
21 Clutch unit
22 Rotational speed sensor
23 Pressure sensor
n_{Mot} Rotational speed
n_{Grenz} Rotational speed limit value
p_{Brems} Brake pressure
p_{Grenz} Brake pressure limit value
v_{Fahr} Vehicle speed
v_{Grenz} Limit value of the vehicle speed
v_{Anfahr} Limit value of the vehicle speed

1-12. (canceled)

13. A method for operating a drive-train (1) of a motor vehicle comprising a drive engine (2), a motor vehicle transmission (4), at least one drive axle (6), and a further axle (18) that is drivingly engagable, the method comprising:
automatically interrupting, in a context of a function, a connection between the drive engine (2) and the at least one drive axle (6) of the motor vehicle, the function being automatically activated when certain conditions exist, and the certain conditions for activating the function comprising activation of a service brake (11) of the motor vehicle and braking the vehicle to rest,
determining a brake pressure (p_{Brems}) when the function is carried out, and
if the brake pressure (p_{Brems}) exceeds a brake pressure limit value (p_{Grenz}), automatically carrying out the driving engagement of the further axle (18) as the function is deactivated for re-starting the motor vehicle.

14. The method according to claim 13, further comprising, if a speed limit (v_{Anfahr}) is exceeded after re-starting, automatically interrupting the driving connection of the further axle (18).

15. The method according to claim 13, further comprising parameterizing the brake pressure limit value (p_{Grenz}) as a function of a mode of operation of the motor vehicle.

16. The method according to claim 15, further comprising determining the mode of operation of the motor vehicle by recognizing components that are connectable to the motor vehicle and which increase a total weight of the motor vehicle.

17. The method according to claim 16, further comprising control-technologically connecting the components to the motor vehicle by a bus system (17).

18. The method according to claim 13, further comprising detecting the brake pressure (p_{Brems}) of at least one brake circuit of the service brake system (11).

19. The method according to claim 13, further comprising effecting a separation and re-establishment of the connection between the drive engine (2) and the at least one drive axle (6) of the motor vehicle via a starting element (3) located between the drive engine (2) and the motor vehicle transmission (4).

20. The method according to claim 13, further comprising using a clutch unit (21) to control engagement of the further axle (18).

21. The method according to claim 13, further comprising using one of an agricultural or a municipal utility vehicle as the motor vehicle.

22. A control unit (13) for a drive-train (1) of a motor vehicle comprising:
a device for regulating a function for separating a connection between a drive engine (2) and at least one drive axle (6) of the vehicle,
the device being designed for automatically controlling a clutch unit (21) for drivingly connecting a further axle (18) to the drive engine (2) and a motor vehicle transmission (4),
the device activating a function in the drive-train (1) which brings about a separation of a connection between the drive engine (2) and the at least one drive axle (6) of the vehicle,
a service brake (11) of the vehicle being actuatable and the vehicle being braked to a rest to activate the function, and
when carrying out the function, a brake pressure (p_{Brems}) being applied to the service brake for braking the vehicle to the rest, the brake pressure being determinable, and the further axle (18) being automatically engaged when the brake pressure exceeds a brake pressure limit value (p_{Grenz}).

23. The control unit (14) according to claim 22, wherein the control unit carries out a method of operating the drive-train (1) of the vehicle, the method including: automatically interrupting, in a context of the function, the connection between the drive engine (2) and the at least one drive axle (6) of the vehicle, the function being automatically activated when certain conditions exist, and the certain conditions for activating the function including activating the service brake (11) and braking the vehicle to rest; determining the brake pressure (p_{Brems}) when the function is carried out; and, if the brake pressure (p_{Brems}) exceeds the brake pressure limit value (p_{Grenz}), carrying out the driving engagement of the further axle (18) automatically as the function is deactivated for re-starting the motor vehicle.

24. The control unit (14) according to claim 23, in combination with a computer program product by which the method of operating the drive-train (1) of the vehicle can be carried out, wherein a routine for activating the function by corresponding control commands stored by software means is implemented.

25. The control unit (14) and the computer program product according to claim 24, in combination with a data carrier on which the computer program product is stored.

26. A method of operating a drive-train of a motor vehicle, the vehicle having a drive engine, a transmission, at least one drive axle and a further axle that is drivingly engagable, the method comprising:
determining, via a control unit, whether a service brake of the motor vehicle has been actuated and whether the vehicle is braked to a stop;
automatically activating a function, via the control unit, if the service brake is actuated and the vehicle is braked to a stop;
in a context of the function, automatically disengaging a starting element to interrupt a connection between the drive engine and the at least one drive axle of the vehicle;
determining, via the control unit, a brake pressure when the function is carried out;
comparing, via the control unit, the determined brake pressure to a brake pressure limit value; and
if the brake pressure exceeds the brake pressure limit value, once the function is deactivated, automatically engaging a clutch to drivingly connect the further axle for re-starting the motor vehicle.
